(19) United States
(12) Patent Application Publication
(10) Pub. No.: US 2015/0212657 A1
(43) Pub. Date: Jul. 30, 2015

(54) Recommending Mobile Device Settings Based on Input/Output Event History

(71) Applicant: Google Inc., (US)

(72) Inventor: William Noah Schilit, Mountain View, CA (US)

(73) Assignee: Google Inc., Mountain View, CA (US)

(21) Appl. No.: 13/721,012

(22) Filed: Dec. 19, 2012

(51) Int. Cl. G06F 3/0482

(52) U.S. Cl. CPC G06F 3/0482

(57) ABSTRACT

Disclosed are apparatus and methods for generating settings-related information, such as recommendations, for device settings. A mobile device can perform a plurality of user interface (UI)-related activities. For each UI-related activity of the plurality of UI-related activities, a determination can be made whether the UI-related activity is a settings-related activity. After determining that the UI-related activity is a settings-related activity, the UI-related activity can be marked as a settings-related activity. Data can be logged related to the settings-related activity in a log. A request to access a settings interface can be received. In response to the request to access the settings interface, data related to one or more settings-related activities can be retrieved from the log. Settings-related information can be generated based on the retrieved data and can be displayed using the mobile device.

### BACKGROUND

Unless otherwise indicated herein, the materials described in this section are not prior art to the claims in this application and are not admitted to be prior art by inclusion in this section.

Mobile devices are ubiquitous in modern communication networks. Many of these mobile devices are “smart phones”, capable of running one or more applications while acting as a communication device. The applications and/or the smart phone itself can have a number of settings subject to user control, such as volume settings, network addresses/names, contact data, and calendar information. A smart phone user can review and change some or all of these settings based on their context, such as location and activity. For example, the user can turn down a ringing volume and/or mute a ringer, prior to watching a movie at a movie theater. After the movie theater completes, the user can turn up the ringing volume and/or un-mute the ringer.

### SUMMARY

In one aspect, a method is provided. A plurality of user interface (UI)-related activities are performed at a mobile device. For each UI-related activity of the plurality of UI-related activities: determining whether the UI-related activity is a settings-related activity; and based on determining that the UI-related activity is a settings-related activity, the activity is marked as a settings-related activity and data related to the settings-related activity is logged in a log. A request to access a settings interface is received. In response to the request to access the settings interface: data related to one or more settings-related activities is retrieved from the log, settings-related information is generated based on the retrieved data, and the settings-related information is displayed using the mobile device.

In another aspect, a computing device is provided. The computing device includes a display, a processor, and a computer-readable storage medium having stored thereon program instructions that, upon execution by the processor, cause the computing device to perform operations. The operations include: performing a plurality of UI-related activities; for each UI-related activity of the plurality of UI-related activities: determining whether the UI-related activity is a settings-related activity, and based on determining that the UI-related activity is a settings-related activity, marking the UI-related activity as a settings-related activity and logging data related to the settings-related activity in a log; receiving a request to access a settings interface; and in response to the request to access the settings interface: retrieving data related to one or more settings-related activities from the log, generating settings-related information based on the retrieved data, and displaying the settings-related information on the display.

In another aspect, an article of manufacture is provided. The article of manufacture includes a computer-readable storage medium having stored thereon program instructions that, upon execution by a computing device, cause the computing device to perform operations. The operations include: performing a plurality of UI-related activities; for each UI-related activity of the plurality of UI-related activities: determining whether the UI-related activity is a settings-related activity, and based on determining that the UI-related activity is a settings-related activity, marking the UI-related activity as a settings-related activity and logging data related to the settings-related activity in a log; receiving a request to access a settings interface; and in response to the request to access the settings interface: retrieving data related to one or more settings-related activities from the log, and generating settings-related information based on the retrieved data.

### BRIEF DESCRIPTION OF THE FIGURES

FIG. 1 is a flow chart of a method, in accordance with an example embodiment.

FIGS. 2A through 2E depict a scenario involving setting-related recommendations for a mobile device, in accordance with an example embodiment.

FIGS. 3A through 3C depict a scenario related to receiving setting-related recommendations for a home entertainment system, in accordance with an example embodiment.

FIG. 4 depicts a distributed computing architecture, in accordance with an example embodiment.

FIG. 5A is a block diagram of a computing device, in accordance with an example embodiment.

FIG. 5B depicts a cloud-based server system, in accordance with an example embodiment.

### DETAILED DESCRIPTION

### Overview

Disclosed herein are techniques for generating recommendations for device settings. Device settings permit control of one or more aspects of a device, such as a mobile telephone, home entertainment equipment, or computer, based on a value of a selected settings variable or variables that can be set using a settings interface. A settings variable for a device is a variable that can be changed to specify different responses by the device.

In one example, a mobile telephone can be instructed to display a settings or setup menu that allows control of providing location information based on a value of a “provide location data” settings variable. As another example, a ringing volume of the mobile telephone can be controlled based on both (a) a mute settings variable, which can enable or disable ringing and (b) a value of a ringing volume variable, which can control loudness of speaker output when ringing is enabled and the mobile telephone is instructed to ring; e.g., when an incoming telephone call is received by the mobile telephone.

As the complexity of devices grows and as these devices become more flexible, settings interfaces can have settings related to a large number of settings variables and types of settings variables. A user of a settings interface can interact with multiple screens in order to find the specific setting that solves their need. For example, changing a “Dock insert sound” of a mobile telephone can involve opening the “Settings” interface, scrolling to the “Docking” menu, access the “Docking” menu, selecting the “Docking sound” item and then finding the desired setting.

While this flexibility can be helpful and useful, the sheer number of settings menus and variables can increase difficulty in navigating and using settings interfaces. Some settings interfaces have duplicated portions to try to address this problem. For example, to change the “Dock insert sound”, a user might access either the “Docking” menu, an “Accessibility” menu, or even a “Sound” menu, perhaps with replicated menus in multiple parts of the settings interface. However, replication of choices and menus can make a navigation space of the settings interface appear even larger to the user, as well as increasing complexity of settings interface design.

Additionally, as users have experience with multiple types of devices, users can learn that terminology and access of settings may change between devices; e.g., “ringing volume” on one mobile telephone might be found under by first accessing a “telephone” menu, then a “loudness” menu, and then selecting a “ring loudness” item, while another mobile telephone can enable the same selection using a “sound” menu and then selecting a “phone ringtone” item, and a third mobile telephone can have dedicated key(s) or button(s) to adjust the ringing volume.

To ease the use of settings interfaces, apparatus and techniques are described herein for generating settings interface recommendations. In some examples, the impetus for changing a setting can come from a recent device interaction, so interaction history acts as speculative user input. Then, recommendations for settings can be based on recent user interface history for the device, particularly for settings-related activities.

Settings-related activities for a device can include: activities involving reviewing and/or changing the settings variable(s) and/or activities performed by the device that can be controlled by one or more settings variable(s). For example, a settings-related activity can involve a response to a change in an environment of the device, where the response is controlled by the settings variable(s). The change in the environment can be human-controlled; e.g., the user can rotate the device, under the control of a sensor; e.g., the device can detect a change of brightness, or from another source; e.g., receive a message from another device or a timer can expire. In some scenarios, the actions taken by the device can take place without human intervention.

For an example of a setting-related activity related to reviewing and/or changing a settings variable, a user can review an “airplane mode” settings variable of a mobile device that initially indicates all connections are allowed. The user can then set the airplane mode variable to disable all network connections; e.g., while traveling via a commercial airline. The change to the airplane mode variable can be stored in a log, such as a user interface related log. Later, the settings interface for the mobile device is activated. The settings interface can search the log for recent settings-related activities, find the settings-related activity of changing the airplane mode variable, and correspondingly provide recommendation(s) involving accessing airplane mode and/or “Data roaming” settings variables as common settings to change when leaving an airplane.

For example of a setting-related activity related to an action taken by the device in response to a change in the environment where the response is controlled by settings variable(s), a mobile device can receive a message and accordingly play a notification, whose sound and volume are controlled by settings variables. Later, the settings interface of the mobile device can be activated. The settings interface can search the log for recent settings-related activities, find the settings-related activity of playing the notification, and correspondingly provide recommendation(s) to involving changing “Default notification sound” and/or setting the “Notification setting volume”.

The use of recommendations can aid use of devices with settings interfaces, teach users about possible choices they have in controlling their devices, and remind users of settings that may no longer be desirable. Providing recommendations can ease navigation of settings interfaces, which can save time and reduce stress of users who are unable and/or unwilling to fully utilize settings interfaces. Further, as devices become more complex and have correspondingly more complex settings interfaces, recommendations based on user activity and/or settings changes can be devised for new settings interfaces and so can aid adoption of new device technologies.

### Example Operations

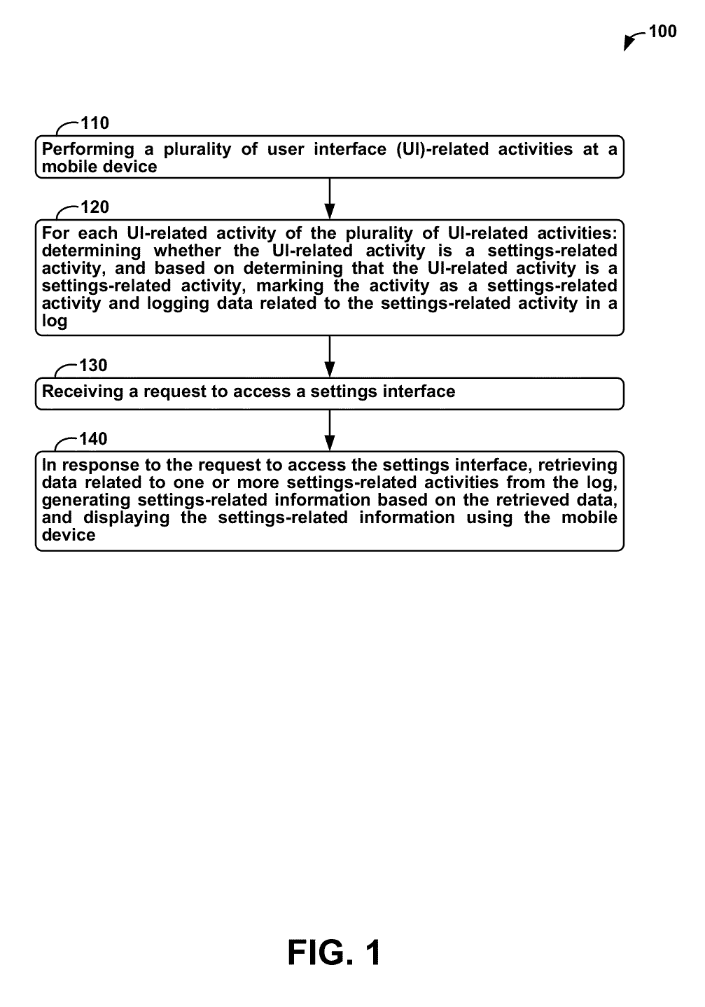

FIG. 1 is a flow chart of method 100, in accordance with an example embodiment. Method 100 begins at block 110, where a mobile device can perform a plurality of UI-related activities. In some embodiments, the plurality of UI-related activities can include at least one UI-related activity selected from the group consisting of a UI-related activity related to a display setting, a UI-related activity related to a network setting, a UI-related activity related to a location setting, and a UI-related activity related to an audio setting. In other embodiments, the plurality of UI-related activities can include at least one UI-related activity selected from the group consisting of a UI-related activity related to a television channel, a UI-related activity related to a picture setting, and a UI-related activity related to an audio setting.

At block 120, for each activity of the plurality of UI-related activities, a determination can be made whether the UI-related activity is a settings-related activity. Based on determining that the UI-related activity is a settings-related activity, the UI-related activity can be marked as a settings-related activity and data related to the settings-related activity can be logged or stored in a log.

At block 130, a request to access a settings interface can be received.

At block 140, in response to the request to access the settings interface, data related to one or more settings-related activities can be retrieved from the log. Settings-related information can be generated based on the retrieved data. The settings-related information can be displayed using the mobile device.

In some embodiments, retrieving data related to one or more settings-related activities from the log can include retrieving data related to n most recent settings-related activities, and where n is an integer greater than zero.

In other embodiments, generating the settings-related information can include determining a highest-ranked settings-related activity of the one or more settings-related activities. In particular other embodiments, retrieving data related to the highest-ranked settings-related activity from the log can include receiving a query for the data related to the one or more settings-related activities, where the query can include one or more associated terms, ranking each settings-related activity stored in the log based on the one or more associated terms, the settings-related activity, and a recency of the settings-related activity. Then, determining the highest-ranked settings-related activity of the one or more settings-related activities can include ranking each settings-related activity of the one or more settings-related activities based on the one or more associated terms, the settings-related activity, and a recency of the settings-related activity.

In even other embodiments, displaying the settings-related information using the mobile device can include generating a settings recommendation display that includes a display of a settings recommendation and a display of the retrieved data forming a basis for the settings recommendation and displaying the settings recommendation display. In yet other embodiments, displaying the settings-related information using the mobile device can include displaying the settings-related information using the settings interface.

### Example Mobile Device User Interface Scenarios

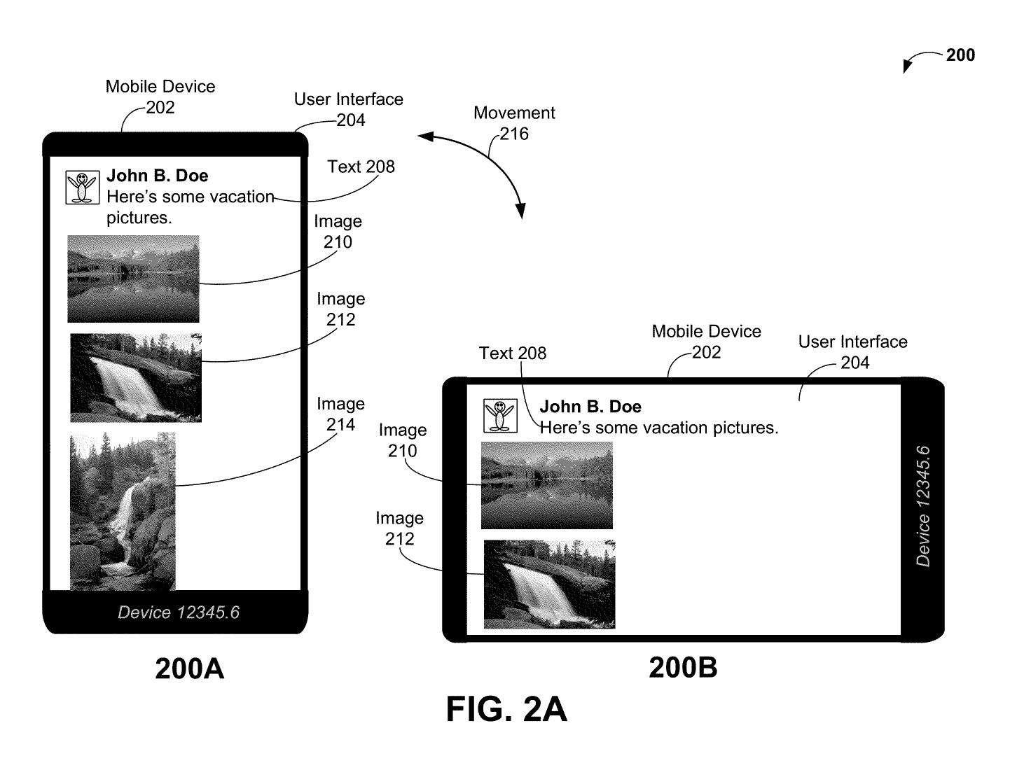

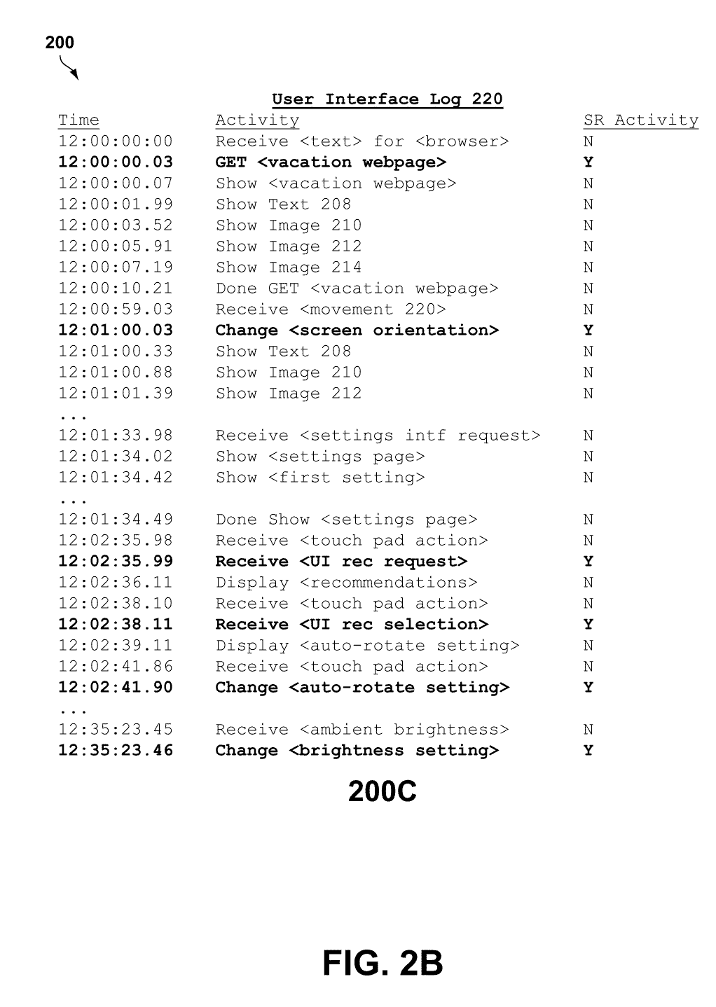

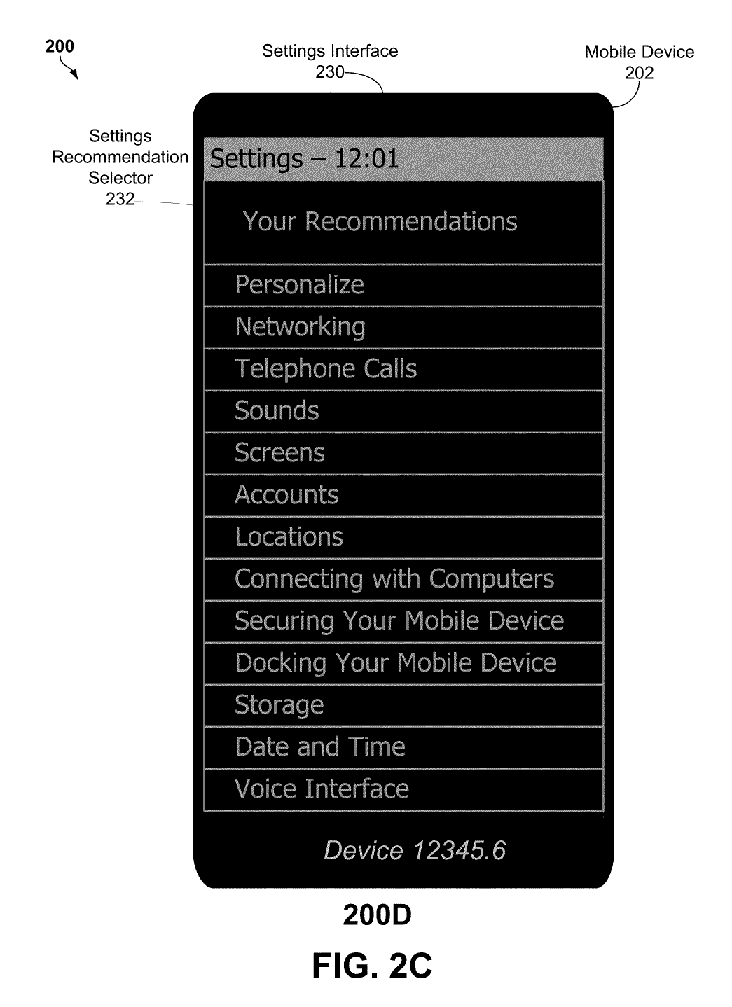

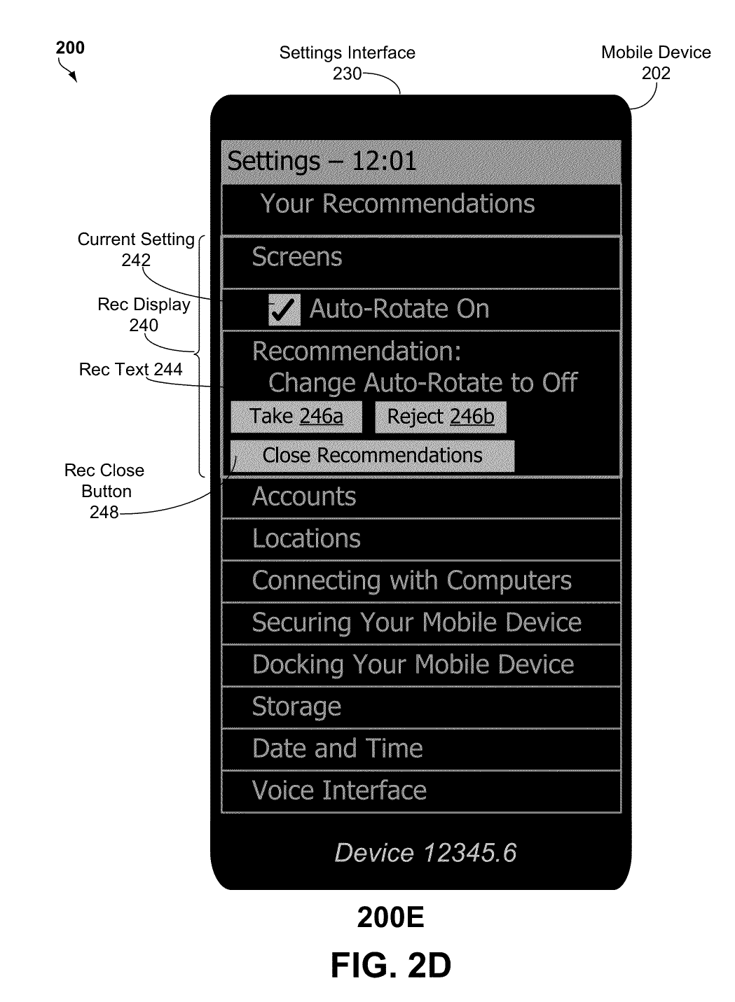

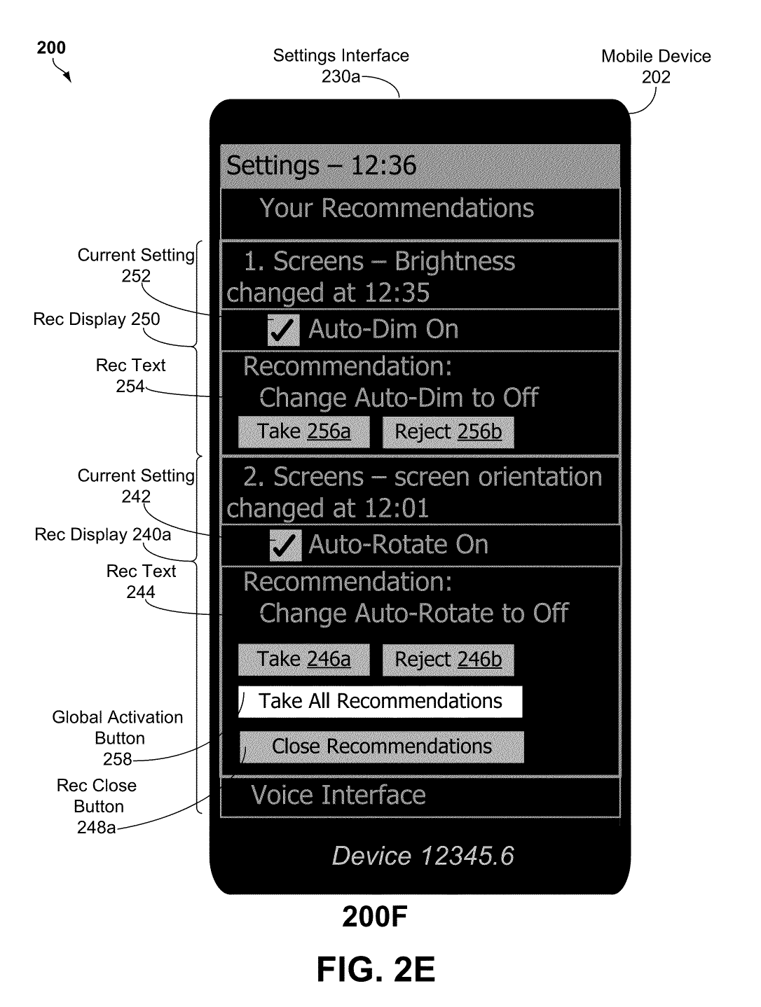

FIGS. 2A through 2E depict scenario 200 involving setting-related recommendations for a mobile device in accordance with an example embodiment. FIG. 2A shows that, at 200A of scenario 200, a display of mobile device 202 is shown in a “portrait” orientation, or with the display of mobile device 202 shown with a height of mobile device 202 greater than a width of mobile device 202. In scenario 200 at 200A, user interface 204 is being utilized by an application configured to display images to load three images 210, 212, 214, along with an image and text 208 associated with “John B. Doe” indicating that the images are “vacation pictures.”

At 200B of scenario 200, mobile device 202 is moved by movement 216. Movement 216 is a rotation gesture. In response to movement 216, user interface 204 can, if properly set, automatically rotate the previous portrait orientation of the display of mobile device 202 to a “landscape” orientation, or with the display of mobile device 202 with the width wider than the height. In scenario 200, user interface is set to automatically rotate the orientation of the display of mobile device 202 in response to rotation gestures, such as movement 216. As such, at 200B, images 210 and 212 are visible when the display of mobile device 202 has a landscape orientation, but image 214 is not visible in this landscape orientation.

For example, movement 216 changes the environment of mobile device 202 from being oriented in a portrait orientation to being oriented in a landscape orientation. In scenario 200, mobile device 202 has an auto-rotate settings variable, set to “Yes”, that controls whether or not mobile device will change a display orientation, in response to physically changing orientations from portrait to landscape (or vice versa). While the auto-rotate settings variable is set to “Yes”, as in scenario 200, the display of mobile device 202 can be oriented in the same fashion as a physical orientation of mobile device 202; e.g., mobile device 202 can reorient the display in response to a movement, such as shown in 200B of FIG. 2A in response to movement 216.

When the auto-rotate settings variable is set to “No”, the display orientation of mobile device 202 may remain fixed, and so the physical orientation of mobile device 202 can differ from the orientation of the display of mobile device 202. For example, in response to movement 216 shown FIG. 2A with the auto-rotate settings variable set to “No”, mobile device 202 can maintain the portrait orientation of the display shown at 200A, and thus the display portrait orientation of mobile device 202 would differ from the physical orientation of mobile device 202

FIG. 2B shows an example user interface log 220 for mobile device 202 at 200C of scenario 200. User interface log 220 logs a number of UI-related activities that occur on mobile device 202 at corresponding times. Example logged UI-related activities shown in log 220 include “Receive <text> for <browser>”, “GET <vacation webpage>”, and “Show <vacation webpage>”. Log 220 utilizes capital letters for network-related operations, such as GETting web pages.

Log 220 can store, data for various types of UI-related activities, such as but not limited to UI-activities in associated with display settings, such as brightness, color, text size, font, etc. values; data for UI-related activities associated with network settings, such as network activation/deactivation status (e.g., “airplane mode”), network addressing information, network access information such as passwords, access codes, network names, pairing information, etc.; UI-related activities associated with location settings, such as enabling/disabling location equipment, and settings regarding providing location information; and UI-related activities associated with audio settings, such as volume values, tones/songs utilized by mobile device 202 (e.g., ringtones), and mute/vibrate settings. Other types of UI-related activities and data thereof can be stored in log 220. Additionally, in other environments and scenarios, such as scenario 300 described below, log 220 can be configured to store different types of UI-related and settings-related activities.

Log 220 also includes a “Settings Related Activity” (SR Activity) field marked as either “Y” for Yes or “N” for No for each logged user interface activity. A settings-related activity can be marked with a “Y” in the Settings Related Activity field of log 220 to allow for quick identification of user interface activities stored in log 220 that are settings-related activities. If the Settings Related Activity field is set to “N” in log 220, the user interface activity is not considered to be a settings-related activity.

FIG. 2B shows example settings-related activities of log 220 in bold, including GETTING a webpage, rotating a window, receiving a “settings intf” or settings interface request, receive recommendation requests and selections, and changing auto-rotate and brightness settings. Recommendations requests and selections are discussed below in the context of FIGS. 2C through 2E.

In other scenarios and embodiments, other user interface activities, settings-related activities and settings are possible as well. In even other scenarios and embodiments, more, different, and/or fewer data items (fields) and/or UI-related activities can be logged in user interface log 220. Log 220 can be stored as a file, a buffer, a circular buffer, and/or using other data storage techniques.

Scenario 200 continues with mobile device 202 receiving a settings interface request and, in response, displaying settings interface 230 shown in FIG. 2C. A settings interface request can include a request to utilize a user interface to present a “settings interface” that can enable display, changing, introducing, and/or removal of values of one or more settings variables.

As shown in FIG. 2C, settings interface 230 can enable display, changing, introducing, and/or removal of values for at least thirteen types of settings variables. These settings values can be related to personalizing mobile device 202, networking, telephone calls, sounds, screens, accounts, locations, connecting with computers, securing and docking mobile device 202, storage, date and time, and a voice interface to mobile device 202. In some embodiments, more, fewer and/or different types of settings variables can be available via settings interface 230.

FIG. 2C shows example settings interface 230 of mobile device 202 with settings recommendation selector 232. In the event that settings recommendations selector 232 is selected, a recommendations request can be made to generate one or more settings recommendation displays.

A settings recommendation display can include information about a settings recommendation to be made based on data retrieved from a log, such as user interface log 220. The data retrieved from the log can include data about settings-related activities. For example, log 220 shows some user-interface related activities stored in log 220 are marked as settings-related activities. Then, in this example, the data for some or all activities marked as settings-related activities can be retrieved from log 220 and used to generate the settings recommendation display(s).

For example, a most recent setting-related activity can be retrieved from the log. FIG. 2C shows that settings interface 230 is being accessed at 12:01. According to log 220, the most recent settings-related activity at that time is likely to be “Chang[ing] screen orientation” that occurred at 12:01:00.03. Note that log 220 includes an entry regarding accessing the settings interface at 12:01:33.98 but has the settings-related activity related indicator set to “N”/No, as accessing the settings interface by mobile device 202 was likely an activity that was did not change a settings variable and was not based on a settings variable; e.g., to access settings interface 230, a user of mobile device 202 likely pressed a “Settings” or “Setup” key or button on a keyboard, a keypad, a device, or a graphical user-interface for the device.

In some embodiments, settings-related activities can be ranked. These rankings can be based on a number of factors, including but not limited to, a time of the activity, a frequency of the activity, a rate of occurrence of the activity, an effect value related to an effect of the activity, and keywords describing the activity.

Regarding effect values, a sound being played can have a “moderate” effect, while changing a brightness value of a display can have a “low” effect. In some cases, the value of a settings-related variable can change the effect value; playing a sound at a volume based on a volume variable set to one on a scale of zero (mute) to ten (loudest possible) can have an effect value of “low”, while playing the same sound at with the volume variable set to nine can have an effect value of “moderate” or even “high”. In some embodiments, effect values can take numerical (e.g., 1-100), alphabetic (e.g., A-F), and/or textual values, such as but not limited to the “low”/“moderate”/“high” values described in this example.

One example of ranking can involve selecting the most recent setting-related activity can be retrieved using a ranking of events based on a difference between the time that the activity occurred and a current time. As another example, activities can be ranked based on recency and effect values; e.g., the most recent activities whose effect value is moderate or high; and a list of N recommendations, N≧1, can be generated and displayed based on N (or more) activities selected according to the recency-and-effect-value ranking Many other examples of ranking settings-related activities and/or generating settings recommendations based on ranked settings-related activities are possible as well.

Log 220 and/or settings recommendations can be searched using one or more keywords describing the activity, and log entries can be evaluated by how closely they match or do not match the keyword(s). In some embodiments, settings interface 230 can be configured to permit entry of keywords, and upon reception of the keywords, log 220 and/or settings recommendations can be searched for keywords. Then, the settings recommendation(s) most closely matching the keywords and/or settings recommendation(s) associated with data that most closely matches the keywords can be displayed using mobile device 202, perhaps using settings interface 230.

In scenario 200, settings-related recommendations are requested. For example, a user of mobile device 200 could touch a touch screen associated with settings interface 230 over a display of recommendation selector 232 to request settings recommendations for settings interface 230. In response to the request for settings-related recommendations, mobile device can generate settings recommendations. These settings recommendations can be displayed using settings recommendation displays. Each settings recommendation display can display one or more settings recommendations, information providing a basis for the settings recommendation, value(s) of variable(s) affected by the settings recommendation, and/or one or more interfaces to permit selection or rejection of the settings recommendation.

FIG. 2D shows an example settings interface 230 displaying a settings recommendations display 240. In scenario 200 at 12:01, the time displayed on settings interface 230 at 200E as shown in FIG. 2D, log 220 indicates a most recent settings-related activity is a “Change <screen orientation>” activity at 12:01:00.03. In scenario 200, settings interface 230 of mobile device 202 can provide settings recommendation(s) related the most recent settings-related activity; e.g., recommendations related to the auto-rotate settings variable, as changing the screen orientation is the most recent settings-related activity.

The settings recommendation can be provided using settings recommendation display 240, as shown in FIG. 2D. Recommendations display 240 includes current setting 242 of the auto-rotate settings variable begin set to “Yes”, recommendation text 244, recommendation activation button 246a, recommendation rejection button 246b, and recommendation close button 248. Recommendation text 244 indicates that settings interface 230 recommends changing the auto-rotate settings variable setting from “On” (active/checked) to “Off” (disabled/unchecked), inferring that settings interface 230 was activated due to a desire to change settings based on the recent change in screen orientation.

Recommendation activation button 246a and recommendation rejection button 246b are buttons that, upon selection, respectively activate or reject the recommendation shown in recommendation display 240. Recommendation close button 248 closes the recommendation without change, perhaps for later selection.

FIG. 2E shows another example settings interface 230a displaying settings recommendations displays 240a and 250. In scenario 200 at 12:36, the time displayed on settings interface 230 at 200E as shown in FIG. 2D, log 220 indicates a recent settings-related activity is a “Change <brightness setting>” activity at 12:35:23.46 and a second-most recent settings-related activity is a “Change <screen orientation>” activity at 12:01:00.03. In scenario 200, settings interface 230a of mobile device 202 can provide recommendation(s) related the last two recent settings-related activities; e.g., recommendations related to screen brightness variable(s) as changing the screen brightness is the most recent settings-related activity and recommendations related to the auto-rotate settings variable, as changing the screen orientation is the second most recent settings-related activity.

The settings recommendations can be provided using settings recommendation displays 240a and 250 as shown in FIG. 2E. Recommendations display 240a is the same as recommendation display 240, except that recommendation display 240a includes information retrieved from log 220 providing a basis for the recommendation; e.g., the information that the “screen orientation changed at 12:01”, a close recommendations button 248a that closes both recommendation displays 240a and 250, and a global recommendations button 258 for taking both recommendations displayed in FIG. 2E using recommendation displays 240a and 250

As with recommendation display 240a, settings recommendation display 250 includes information providing a basis for the recommendation; e.g., the information from log 220 that the “screen brightness changed at 12:35.” Recommendation display 250 also includes recommendation text 254 to “change” the “auto-dim” settings variable to “off” and the current setting 252 of the auto-dim variable being set to checked/on. Also, recommendation display 250 includes recommendation activation button 256a and recommendation rejection button 256b, which are buttons that, upon selection, respectively activate or reject the recommendation shown in recommendation display 250.

In scenario 200, recommendation display 250 is shown as the first, or most highly ranked, recommendation, as the ranking of recommendations by settings interface 230a is based on recency. The change brightness settings-related activity is most recent, and thus recommendation display 250 is the highest ranked recommendation.

### Example Home Entertainment Scenarios

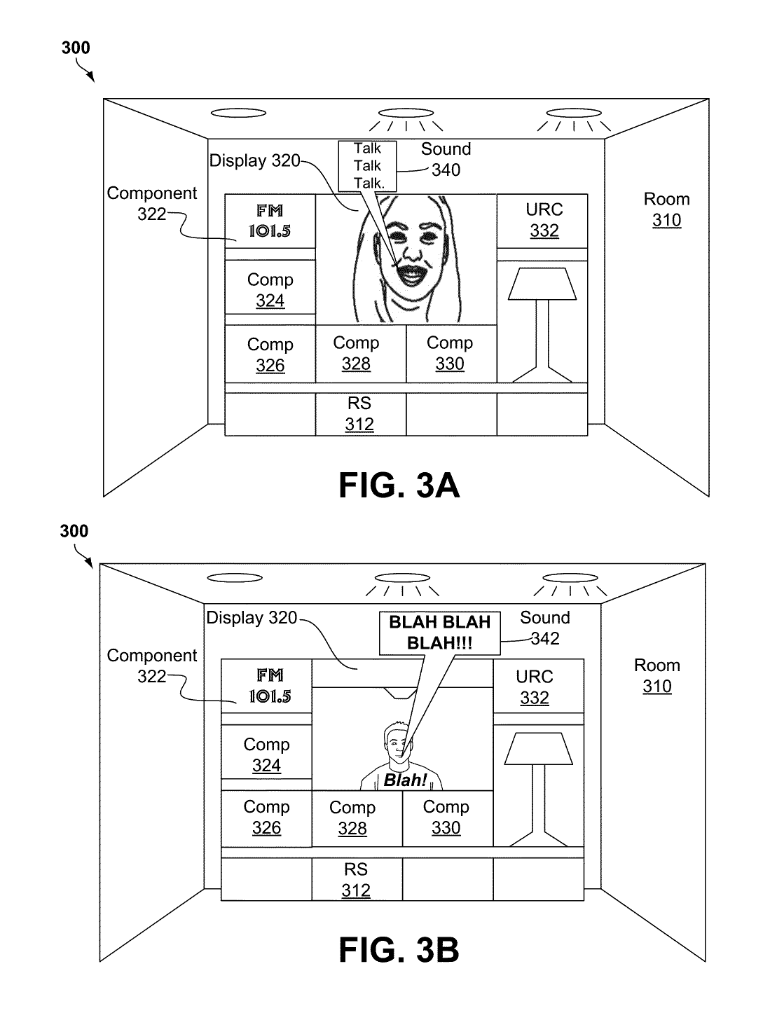

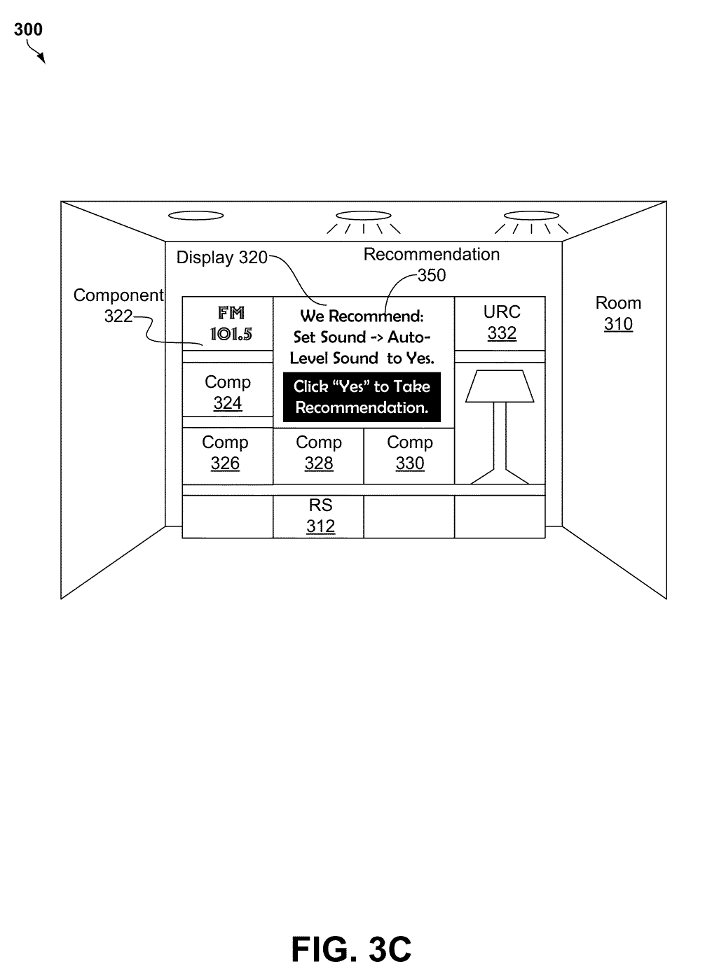

FIGS. 3A through 3C depict scenario 300 related to receiving setting-related recommendations for a home entertainment system, in accordance with an example embodiment.

FIG. 3A shows room 310 containing recommendation system (RS) 312, display 320, components 322, 324, 326, 328, 330, and universal remote controller (URC) 332. Universal remote controller 332 is configured to receive remote-control signals from a remote control (not shown in the Figures) and transmit corresponding remote-control signals to display 330 and/or components 334a-334c. In some embodiments, the functionality of recommendation system 312 can be embodied within display 320 and/or one or more of components 322, 324, 326, 328, and 330; that is, recommendation system 312 can, but need not be, a stand-alone device. In particular embodiments, recommendations associated with components 322, 324, 326, 328, and/or 330 can be provided to display 320 to be shown to a viewer of display 320 who may be using components 322, 324, 326, 328, and/or 330.

Recommendation system 312 can be configured to receive information about UI-related activities for at least display 320 and/or one or more of components 322, 324, 326, 328, 330, determine whether each UI-related activity is a settings-related activity, log at least the settings-related events, and generate settings recommendations for display 320 and/or one or more of components 322, 324, 326, 328, 330. Universal remote controller 332 can be configured to decode a command from recommendation system 312 to a device, translate the command into a remote-control command suitable for use by the device, and transmit the remote-control command to the device.

Scenario 300 begins with display 320 displaying content shown in FIG. 3A and playing sound 340 at a moderate volume. During scenario 300, volume settings for sounds produced by display 320 are not changed. Later, the content shown on display 320 in FIG. 3A changes to the content shown on display 320 in FIG. 3B. Display 320 plays accompanying sound 342 at a relatively-loud volume in comparison to sound 340.

During scenario 300, after hearing sound 342, a viewer of display 320 accesses a settings interface for display 320. The settings interface for display 320 can communicate with recommendation system 312, which can search a log similar to log 220 for settings-related activities, possibly rank settings-related activities, and then generate settings recommendations and recommendations displays based on the settings-related activities, such as discussed above with respect to FIGS. 2A through 2E.

In scenario 300, recommendation system 312 can generate recommendations based on searching for and finding a most recent settings-related activity; in this scenario, recommendation system 312 can find that the most recent settings-related activity is related to increasing volume of sounds played by display 320 before playing sound 342. Then, recommendation system 312 determine that an “auto level sound” settings variable can be used to play sounds without an excessive amount of volume variability; i.e., at a generally level or moderate volume without begin too loud or too soft for most people.

In scenario 300, the auto level sound settings variable was set to “No” (meaning “Off”) when sound 342 was played, and so recommendations system 312 can generate recommendation 350, as shown in FIG. 3C, to recommend to set the auto level sound settings variable to “Yes” (meaning “On”). Recommendations system 312 can also advise the viewer of display 320 to “click” or use the remote control to select “‘Yes’ to Take [the] Recommendation”. In scenario 300, if the user uses the remote control to select Yes, recommendations system 312 can set the auto level sound settings variable to “Yes”.

### Example Data Network

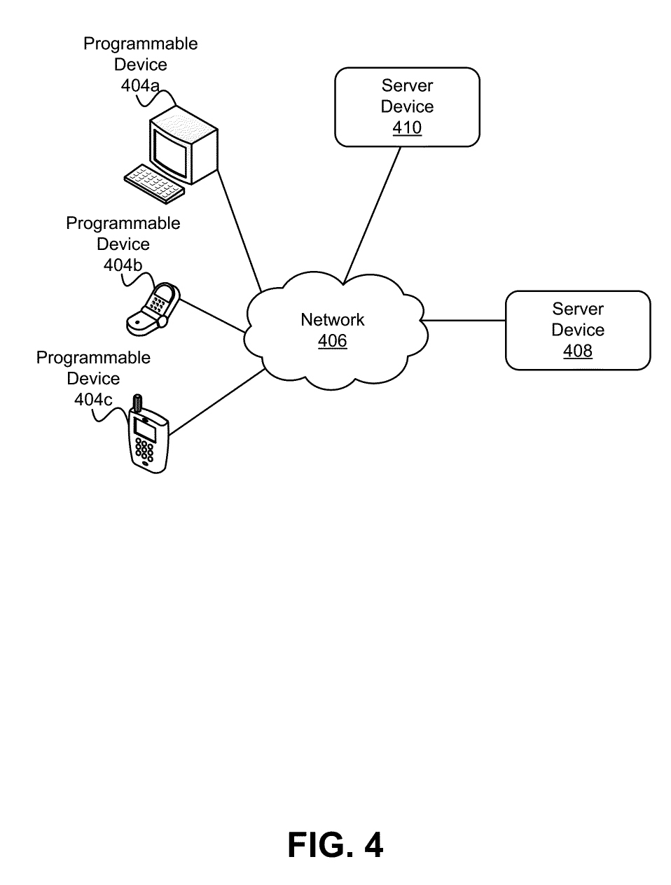

FIG. 4 shows server devices 408, 410 configured to communicate, via network 406, with programmable devices 404a, 404b, and 404c. Network 406 may correspond to a LAN, a wide area network (WAN), a corporate intranet, the public Internet, or any other type of network configured to provide a communications path between networked computing devices. The network 406 may also correspond to a combination of one or more LANs, WANs, corporate intranets, and/or the public Internet.

Although FIG. 4 only shows three programmable devices, distributed application architectures may serve tens, hundreds, or thousands of programmable devices. Moreover, programmable devices 404a, 404b, and 404c (or any additional programmable devices) may be any sort of computing device, such as an ordinary laptop computer, desktop computer, network terminal, wireless communication device (e.g., a cell phone or smart phone), and so on. In some embodiments, programmable devices 404a, 404b, and 404c may be dedicated to the design and use of software applications. In other embodiments, programmable devices 404a, 404b, and 404c may be general purpose computers that are configured to perform a number of tasks and need not be dedicated to software development tools.

Server devices 408, 410 can be configured to perform one or more services, as requested by programmable devices 404a, 404b, and/or 404c. For example, server device 408 and/or 410 can provide content to programmable devices 404a-404c. The content can include, but is not limited to, web pages, hypertext, scripts, binary data such as compiled software, images, audio, and/or video.

The content can include compressed and/or uncompressed content. The content can be encrypted and/or unencrypted. Other types of content are possible as well.

As another example, server device 408 and/or 410 can provide programmable devices 404a-404c with access to software for database, search, computation, graphical, audio, video, World Wide Web/Internet utilization, and/or other functions. Many other examples of server devices are possible as well.

### Computing Device Architecture

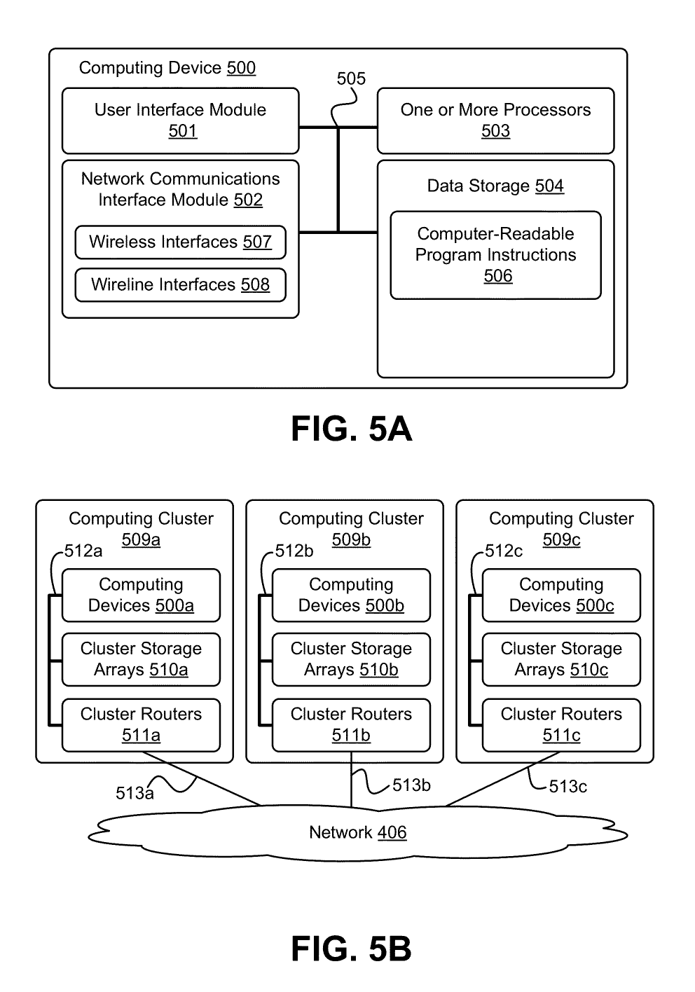

FIG. 5A is a block diagram of computing device (e.g., system) 500, in accordance with an example embodiment. In particular, computing device 500 shown in FIG. 5A can be configured to perform one or more functions or blocks of method 100, mobile device 202, settings interfaces 230, 230a, display 320, server devices 408, 410, network 406, and/or one or more of programmable devices 404a, 404b, and 404c. Computing device 500 may include a user interface module 501, a network-communication interface module 502, one or more processors 503, and data storage 504, all of which may be linked together via a system bus, network, or other connection mechanism 505.

User interface module 501 can be operable to send data to and/or receive data from external user input/output devices. For example, user interface module 501 can be configured to send and/or receive data to and/or from user input devices such as a keyboard, a keypad, a touch screen, a computer mouse, a microphone, a track ball, a joystick, a camera, a voice recognition module, and/or other similar devices. User interface module 501 can also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, either now known or later developed. User interface module 501 can also be configured with one or more sound output devices configured to generate audible output(s), such as a speaker, speaker jack, audio output port, audio output device, earphones, and/or other similar devices.

Network-communications interface module 502 can include one or more wireless interfaces 507 and/or one or more wireline interfaces 508 that are configurable to communicate via a network, such as network 406 shown in FIG. 4. Wireless interfaces 507 can include one or more wireless transmitters, receivers, and/or transceivers, such as a Bluetooth transceiver, a Zigbee transceiver, a Wi-Fi transceiver, a WiMAX transceiver, and/or other similar type of wireless transceiver configurable to communicate via a wireless network. Wireline interfaces 508 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network communications interface module 502 can be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well or in addition to those listed herein to secure (and then decrypt/decode) communications.

Processors 503 can include one or more general purpose processors and/or one or more special purpose processors (e.g., digital signal processors, application specific integrated circuits, etc.). Processors 503 can be configured to execute computer-readable program instructions 506 that are contained in the data storage 504 and/or other instructions as described herein.

Data storage 504 can include one or more computer-readable storage media that can be read and/or accessed by at least one of processors 503. The one or more computer-readable storage media can include volatile and/or non-volatile storage components, such as optical, magnetic, organic or other memory or disc storage, which can be integrated in whole or in part with at least one of processors 503. In some embodiments, data storage 504 can be implemented using a single physical device (e.g., one optical, magnetic, organic or other memory or disc storage unit), while in other embodiments, data storage 504 can be implemented using two or more physical devices.

Data storage 504 can include computer-readable program instructions 506 and perhaps additional data, such as but not limited to data used by one or more processes and/or threads of a software application. In some embodiments, data storage 504 can additionally include storage required to perform at least part of the herein-described methods and techniques and/or at least part of the functionality of the herein-described devices and networks.

### Cloud-Based Servers

FIG. 5B depicts a network 406 of computing clusters 509a, 509b, 509c arranged as a cloud-based server system in accordance with an example embodiment. For example, server devices 408 and/or 410 can be cloud-based devices that store program logic and/or data of cloud-based applications and/or services. In some embodiments, server devices 408 and/or 410 can be a single computing device residing in a single computing center. In other embodiments, server device 408 and/or 410 can include multiple computing devices in a single computing center, or even multiple computing devices located in multiple computing centers located in diverse geographic locations. For example, FIG. 5 depicts each of server devices 408 and 410 residing in different physical locations.

In some embodiments, data and services at server devices 408 and/or 410 can be encoded as computer readable information stored in non-transitory, tangible computer readable media (or computer readable storage media) and accessible by programmable devices 404a, 404b, and 404c, and/or other computing devices. In some embodiments, data at server devices 408 and/or 410 can be stored on a single disk drive or other tangible storage media, or can be implemented on multiple disk drives or other tangible storage media located at one or more diverse geographic locations.

FIG. 5B depicts a cloud-based server system in accordance with an example embodiment. In FIG. 5B, the functions of server device 408 and/or 410 can be distributed among three computing clusters 509a, 509b, and 508c. Computing cluster 509a can include one or more computing devices 500a, cluster storage arrays 510a, and cluster routers 511a connected by a local cluster network 512a. Similarly, computing cluster 509b can include one or more computing devices 500b, cluster storage arrays 510b, and cluster routers 511b connected by a local cluster network 512b. Likewise, computing cluster 509c can include one or more computing devices 500c, cluster storage arrays 510c, and cluster routers 511c connected by a local cluster network 512c.

In some embodiments, each of the computing clusters 509a, 509b, and 509c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 509a, for example, computing devices 500a can be configured to perform various computing tasks of server 408. In one embodiment, the various functionalities of server 408 can be distributed among one or more of computing devices 500a, 500b, and 500c. Computing devices 500b and 500c in computing clusters 509b and 509c can be configured similarly to computing devices 500a in computing cluster 509a. On the other hand, in some embodiments, computing devices 500a, 500b, and 500c can be configured to perform different functions.

In some embodiments, computing tasks and stored data associated with server devices 408 and/or 410 can be distributed across computing devices 500a, 500b, and 500c based at least in part on the processing requirements of server devices 408 and/or 410, the processing capabilities of computing devices 500a, 500b, and 500c, the latency of the network links between the computing devices in each computing cluster and between the computing clusters themselves, and/or other factors that can contribute to the cost, speed, fault-tolerance, resiliency, efficiency, and/or other design goals of the overall system architecture.

The cluster storage arrays 510a, 510b, and 510c of the computing clusters 509a, 509b, and 509c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of server devices 408 and/or 410 can be distributed across computing devices 500a, 500b, and 500c of computing clusters 509a, 509b, and 509c, various active portions and/or backup portions of these components can be distributed across cluster storage arrays 510a, 510b, and 510c. For example, some cluster storage arrays can be configured to store the data of server device 508, while other cluster storage arrays can store data of server device 510. Additionally, some cluster storage arrays can be configured to store backup versions of data stored in other cluster storage arrays.

The cluster routers 511a, 511b, and 511c in computing clusters 509a, 509b, and 509c can include networking equipment configured to provide internal and external communications for the computing clusters. For example, the cluster routers 511a in computing cluster 509a can include one or more internet switching and routing devices configured to provide (i) local area network communications between the computing devices 500a and the cluster storage arrays 501a via the local cluster network 512a, and (ii) wide area network communications between the computing cluster 509a and the computing clusters 509b and 509c via the wide area network connection 513a to network 406. Cluster routers 511b and 511c can include network equipment similar to the cluster routers 511a, and cluster routers 511b and 511c can perform similar networking functions for computing clusters 509b and 509b that cluster routers 511a perform for computing cluster 509a.

In some embodiments, the configuration of the cluster routers 511a, 511b, and 511c can be based at least in part on the data communication requirements of the computing devices and cluster storage arrays, the data communications capabilities of the network equipment in the cluster routers 511a, 511b, and 511c, the latency and throughput of local networks 512a, 512b, 512c, the latency, throughput, and cost of wide area network links 513a, 513b, and 513c, and/or other factors that can contribute to the cost, speed, fault-tolerance, resiliency, efficiency and/or other design goals of the moderation system architecture.

### CONCLUSION

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method, comprising:
performing a plurality of user interface (UI)-related activities at a mobile device;
for each UI-related activity of the plurality of UI-related activities:
determining whether the UI-related activity is a settings-related activity, wherein the settings-related activity is associated with one or more settings variables that specify one or more responses of the mobile device to a change in an environment, and
based on determining that the UI-related activity is a settings-related activity,
marking the UI-related activity as a settings-related activity and
logging data related to the settings-related activity in a log;
receiving a request to access a settings interface associated with the one or more settings variables; and
in response to the request to access the settings interface,
retrieving data related to one or more settings-related activities from the log,
generating a settings recommendation based on the retrieved data, wherein the settings recommendation comprises one or more recommended values of the one or more settings variables, and
displaying at least the settings recommendation using the mobile device.

2. The method of claim 1, wherein the plurality of UI-related activities comprise at least one UI-related activity selected from the group consisting of a UI-related activity associated with a display setting, a UI-related activity associated with a network setting, a UI-related activity associated with a location setting, and a UI-related activity associated with an audio setting.

3. The method of claim 1, wherein the plurality of UI-related activities comprise at least one UI-related activity selected from the group consisting of a UI-related activity associated with a television channel, a UI-related activity associated with a picture setting, and a UI-related activity associated with an audio setting.

4. The method of claim 1, wherein retrieving data related to one or more settings-related activities from the log comprises retrieving data related to n most recent settings-related activities, and wherein n is an integer greater than zero.

5. The method of claim 1, wherein generating the settings recommendation comprises:
determining a highest-ranked settings-related activity of the one or more settings-related activities.

6. The method of claim 5, wherein retrieving data related to the one or more settings-related activities from the log comprises receiving a query for the data related to the one or more settings-related activities, the query comprising one or more associated terms, and
wherein determining the highest-ranked settings-related activity of the one or more settings-related activities comprises ranking each settings-related activity of the one or more settings-related activities based on the one or more associated terms, the settings-related activity, and a recency of the settings-related activity.

7. The method of claim 1, wherein displaying the at least the settings recommendation comprises:
generating a settings recommendation display comprising a display of the settings recommendation and a display of the retrieved data forming a basis for the settings recommendation; and
displaying the settings recommendation display.

8. The method of claim 1, wherein displaying the at least the settings recommendation comprises displaying the at least the settings recommendation using the settings interface.

9. A computing device, comprising:
a display;
a processor; and
a computer-readable storage medium having stored thereon program instructions that, upon execution by the processor, cause the computing device to perform operations comprising:
performing a plurality of user interface (UI)-related activities,
for each UI-related activity of the plurality of UI-related activities:
determining whether the UI-related activity is a settings-related activity wherein the settings-related activity is associated with one or more settings variables that specify one or more responses of the mobile device to a change in an environment, and
based on determining that the UI-related activity is a settings-related activity,
marking the UI-related activity as a settings-related activity and
logging data related to the settings-related activity in a log,
receiving a request to access a settings interface associated with the one or more settings variables, and
in response to the request to access the settings interface:
retrieving data related to one or more settings-related activities from the log,
generating a settings recommendation based on the retrieved data, wherein the settings recommendation comprises one or more recommended values of the one or more settings variables, and
displaying at least the settings recommendation on the display.

10. The computing device of claim 9, wherein the plurality of UI-related activities comprise at least one UI-related activity selected from the group consisting of a UI-related activity associated with a display setting, a UI-related activity associated with a network setting, a UI-related activity associated with a location setting, and a UI-related activity associated with an audio setting.

11. The computing device of claim 9, wherein retrieving data related to the one or more settings-related activities from the log comprises retrieving data related to n most recent settings-related activities, and wherein n is an integer greater than zero.

12. The computing device of claim 9, wherein retrieving data related to the one or more settings-related activities from the log comprises receiving a query for the data related to the one or more settings-related activities, the query comprising one or more associated terms; and
wherein generating the settings recommendation comprises:
ranking each settings-related activity of the one or more settings-related activities based on the one or more associated terms, the settings-related activity, and a recency of the settings-related activity; and
determining a highest-ranked settings-related activity of the ranked one or more settings-related activities.

13. The computing device of claim 9, wherein displaying the at least the settings recommendation comprises:
generating a settings recommendation display comprising a display of the settings recommendation and a display of the retrieved data forming a basis for the settings recommendation; and
displaying the settings recommendation display on the display.

14. The computing device of claim 9, wherein displaying the at least the settings recommendation comprises displaying the at least the settings recommendation on the display using the settings interface.

15. An article of manufacture including a non-transitory computer-readable storage medium having stored thereon program instructions that, upon execution by a computing device, cause the computing device to perform operations comprising:
performing a plurality of user interface (UI)-related activities;
for each UI-related activity of the plurality of UI-related activities:
determining whether the UI-related activity is a settings-related activity, wherein the settings-related activity is associated with one or more settings variables that specify one or more responses of the mobile device to change in an environment, and
based on determining that the UI-related activity is a settings-related activity,
marking the UI-related activity as a settings-related activity and
logging data related to the settings-related activity in a log;
receiving a request to access a settings interface associated with the one or more settings variables; and
in response to the request to access the settings interface:
retrieving data related to one or more settings-related activities from the log, and
generating a settings recommendation based on the retrieved data, wherein the settings recommendation comprises one or more recommended values of the one or more settings variables, and
displaying at least the settings recommendation.

16. The article of manufacture of claim 15, wherein the plurality of UI-related activities comprise at least one UI-related activity selected from the group consisting of a UI-related activity related to a display setting, a UI-related activity related to a network setting, a UI-related activity related to a location setting, and a UI-related activity related to an audio setting.

17. The article of manufacture of claim 15, wherein retrieving data related to the one or more settings-related activities from the log comprises retrieving data related to n most recent settings-related activities, and wherein n is an integer greater than zero.

18. The article of manufacture of claim 15, wherein retrieving data related to the one or more settings-related activities from the log comprises receiving a query for the data related to the one or more settings-related activities, the query comprising one or more associated terms; and
wherein generating the settings recommendation comprises:
ranking each settings-related activity of the one or more settings-related activities based on the one or more associated terms, the settings-related activity, and a recency of the settings-related activity; and
determining a highest-ranked settings-related activity of the ranked one or more settings-related activities.

19. The article of manufacture of claim 15, wherein displaying the at least the settings recommendation comprises:
generating a settings recommendation display comprising a display of the settings recommendation and a display of the retrieved data forming a basis for the settings recommendation, wherein the settings recommendation comprises one or more recommended values of the one or more settings variables; and
displaying the settings recommendation display.

20. The article of manufacture of claim 15, wherein displaying the at least the settings recommendation comprises displaying the at least the settings recommendation using the settings interface.
